(19) United States
(12) Patent Application Publication
(10) Pub. No.: US 2026/0034508 A1
(43) Pub. Date: Feb. 5, 2026

(54) INSTALLATION AND METHOD FOR SEPARATION OF CARBON DIOXIDE FROM THE AMBIENT AIR

(71) Applicant: VOLKSWAGEN AG, Wolfsburg (DE)

(72) Inventors: Oliver Gröger, Schwülper (DE); Frank Beger, Hannover (DE); Christian Heimermann, Wolfsburg (DE); Nadine Simon, Wolfsburg (DE); Christine Schütz, Vordorf (DE); Marcel Wiegel, Gardelegen (DE); Marc Rüggeberg, Braunschweig (DE)

(21) Appl. No.: 19/106,188

(22) PCT Filed: Sep. 7, 2023
(86) PCT No.: PCT/EP2023/074590

§ 371 Date: Feb. 24, 2025

(30) Foreign Application Priority Data
Sep. 14, 2022 (DE) 10 2022 123 521.1

(51) Int. Cl. B01D 53/62; B01D 53/83; B01D 53/96

(52) U.S. Cl. CPC B01D 53/62; B01D 53/83; B01D 53/96; B01D 2257/504; B01D 2258/06; B01D 2259/40092; B01D 2259/40094; B01D 2259/40098

(57) ABSTRACT

An installation for separating carbon dioxide from ambient air is disclosed. The installation includes an adsorption chamber configured to bind carbon dioxide from ambient air to a sorbent, a desorption chamber configured to release carbon dioxide from the sorbent, and a cooling chamber configured to cool the sorbent after desorption. A heating mechanism is disposed within the desorption chamber to facilitate the release of carbon dioxide. The installation further includes a continuous belt configured to support or contain the sorbent and a drive element configured to transport the continuous belt through the adsorption chamber, the desorption chamber, and the cooling chamber. Also disclosed is a method for separating carbon dioxide from ambient air using the installation.

### RELATED APPLICATIONS

The present application claims priority to International Patent Application No. PCT/EP2023/074590 to Gröger et al., filed Sep. 7, 2023, which claims priority from German Patent App. No. DE 10 2022 123 521.1, filed Sep. 14, 2022, the contents of each being incorporated by reference in their entirety herein.

### TECHNICAL FIELD

The present disclosure relates to a system and method for separating carbon dioxide from the ambient air and to a method for separating carbon dioxide from the ambient air using such a system.

### BACKGROUND

The need to slow global climate change, accelerated by the emissions of greenhouse gases, is very urgent. Especially, the rise in atmospheric carbon dioxide levels must be significantly reduced. To lower the carbon dioxide content in the ambient air and achieve climate neutrality, it is necessary not only to decrease carbon dioxide emissions but also to appropriately compensate for unavoidable carbon dioxide emissions. One known method for separating carbon dioxide from the ambient air is the so-called direct air capture method, in which ambient air is conducted through an adsorption chamber, and the carbon dioxide contained in the ambient air is at least partly separated. Such methods are suited for reducing the carbon dioxide content of the atmosphere and thereby counteracting climate change. The development of powerful and efficient processes for separating carbon dioxide from the atmosphere is essential. One option is the use of chemisorption for capturing carbon dioxide. In this process, carbon dioxide is chemically bound and subsequently desorbed from the sorbent by heating while lowering the pressure, so as to concentrate the released carbon dioxide and supply it to an intermediate storage unit or a downstream process that requires carbon dioxide as the starting material.

The energy efficiency during the heating and cooling phases of the sorption material is crucial for determining the amount of energy required and thus for the acceptance of the technology. In general, a large part of the system is thermally involved during the sorption and subsequent desorption of carbon dioxide, which negatively impacts the energy balance of the method. Additionally, negative pressure is applied to the sorbent in the desorption phase, which further increases the energy demand of methods known from prior art.

The majority of known methods for separating carbon dioxide from ambient air operate based on a cyclical process, employing a combination of pressure and temperature changes. In the first process step, carbon dioxide present in the atmospheric air is bound in a sorption element, thereby reducing the carbon dioxide content in the atmospheric air. The carbon dioxide bound in the sorption element can be released again in a second process step and can either be stored or supplied to a further process in which the released carbon dioxide is needed as the starting material. As a result of the development of suitable adsorption materials and their technical implementation in corresponding adsorption systems, efficient and energetically effective capture of carbon dioxide can be achieved.

One challenge is the development of efficient adsorption systems in which the sorption elements are arranged and/or designed in such a way that, on the one hand, the adsorption and desorption of carbon dioxide occur optimally and, on the other hand, a comparatively cost-effective system concept can be implemented. In particular, the heating and cooling phases influence the process costs, while the design of the sorption element and the process area affect the system costs.

The disadvantage of such discontinuously operating systems, however, is that they are highly complex. Extensive design effort is needed, particularly for sealing and heating the sorption chamber as well as for generating a vacuum. Moreover, cyclical temperature changes and the high thermal capacity of the system result in lower energy efficiency.

A system and a method for capturing carbon dioxide from the ambient air is known from WO 2020/148460 A1. The system comprises a membrane that is at least partly permeable to air and contains a solid sorbent for absorbing carbon dioxide; at least one sorption chamber; at least one regeneration chamber; means for transporting the membrane from the sorption chamber to the regeneration chamber; an inlet for receiving air located at one end of the membrane; and an outlet for discharging air enriched with carbon dioxide located at the other end of the membrane in the sorption chamber. The system is configured to allow the air to flow through the membrane from the inlet to the outlet. The system furthermore comprises means for flowing stripping gas through the membrane into the regeneration chamber; at least one outlet for discharging carbon dioxide present in the regeneration chamber; and heating means for heating the regeneration chamber.

WO 2020/046 864 A1 describes a carbon dioxide scrubber for a building comprising an adsorption chamber through which an adsorption air flow is directed; a regeneration chamber through which a regeneration air flow is directed; and a divider wall separating the adsorption chamber from the regeneration chamber. A carbon dioxide sorbent bed extends across the adsorption chamber and the regeneration chamber. The carbon dioxide sorbent bed is configured to adsorb carbon dioxide from the adsorption air flow into the sorbent bed and exhaust carbon dioxide from the carbon dioxide sorbent bed into the regeneration air flow.

WO 2019/165 151 A1 discloses a system and a method for passively collecting atmospheric carbon dioxide. The system comprises a collection chamber having a first opening and a sorbent regeneration system. The system also comprises a capture body, which is coupled to and movable by a support structure. The capture body includes a sorbent material and is movable by the support structure to be in a collection configuration in which at least a portion of the capture body is in contact with a natural air flow outside the harvest chamber so that atmospheric carbon dioxide is captured by the sorbent material, and a release configuration in which at least a portion of the capture body holding captured carbon dioxide is processed by the regeneration system inside the harvest chamber so that captured carbon dioxide is released to form an enriched gas.

### SUMMARY

Aspects of the present disclosure are directed to increasing the energy efficiency of a system for separating carbon dioxide from the ambient air and to overcome the disadvantages known from the prior art.

According to some aspects of the present disclosure, the described functionality is achieved by the independent claims of the present application, as detailed below. Additional aspects are disclosed in the dependent claims, the description, and the drawings. Features, advantages, and possible implementations described in connection with one subject of the independent claims should be understood as applicable, at least analogously, to other independent claims, as well as any combination of independent and dependent claims.

In some examples, systems and methods are disclosed for separating carbon dioxide from the ambient air, which comprises an adsorption chamber for binding carbon dioxide from the ambient air in a sorbent, a desorption chamber for releasing the carbon dioxide bound in the sorbent, and a cooling chamber for cooling the sorbent after the carbon dioxide bound in the sorbent has been released, as well as an endless tape, which comprises or carries the sorbent, and a drive element, which is configured to move the endless tape through the adsorption chamber, the desorption chamber, and the cooling chamber. Heating means for heating the sorbent are arranged in the desorption chamber.

The various embodiments of the present disclosure can advantageously be combined with one another, unless they are implemented differently in the individual case.

### BRIEF DESCRIPTION OF THE DRAWINGS

Aspects of the present disclosure will be described hereafter in exemplary embodiments based on the associated drawings. In the drawings:

FIG. 1 shows a preferred exemplary embodiment of a system for separating carbon dioxide from the ambient air, according to some aspects of the present disclosure;

FIG. 2 shows a further preferred exemplary embodiment of a system for separating carbon dioxide from the ambient air, according to some aspects of the present disclosure;

FIG. 3 shows an exemplary embodiment of an endless tape for such a system, according to some aspects of the present disclosure;

FIG. 4 shows a further exemplary embodiment of an endless tape for such a system, according to some aspects of the present disclosure;

FIG. 5 shows a further exemplary embodiment of an endless tape for such a system, according to some aspects of the present disclosure;

FIG. 6 shows a schematic representation of the design of a preferred exemplary embodiment of such an endless tape, according to some aspects of the present disclosure;

FIG. 7 shows a further exemplary embodiment of such an endless tape, according to some aspects of the present disclosure;

FIG. 8 shows an alternative exemplary embodiment of an endless tape for such a system, according to some aspects of the present disclosure; and

FIG. 9 shows a flow chart for carrying out a method for separating carbon dioxide from the ambient air, according to some aspects of the present disclosure.

### DETAILED DESCRIPTION

In various examples disclosed herein, the system enables a comparatively simple and cost-effective separation of carbon dioxide from ambient air. A continuous revolution of the endless tape facilitates simultaneous absorption, desorption, and cooling within corresponding sections of the endless tape, which serves as a carrier for the sorbent. As a result, constant heating, evacuation, and cooling of a sorption chamber are avoided. Instead, optimal conditions for the adsorption and subsequent desorption of carbon dioxide can be established separately in the adsorption chamber and the desorption chamber. Additionally, the energy demand is significantly reduced compared to known solutions, as it is not necessary to heat and cool the entire sorption chamber; rather, only the endless tape and the sorbent require heating. The inclusion of a cooling chamber allows for rapid cooling of the endless tape following desorption, enabling a section of the endless tape to be cooled over a short distance to a temperature suitable for optimal carbon dioxide adsorption.

In some examples, the heating mechanism in the desorption chamber includes an infrared emitter. The infrared emitter directs high-energy radiation into the endless tape, locally heating the sorbent to a desorption temperature of at least 90° C. This targeted heating eliminates the need to heat the entire desorption chamber to the desorption temperature, as only the endless tape and the sorbent operatively connected to it are heated.

Alternatively or additionally, the heating mechanism in the desorption chamber may include a microwave emitter. The microwave emitter delivers high-energy radiation to the endless tape, locally heating the sorbent to at least 90° C. This localized heating ensures that the entire desorption chamber does not need to reach the desorption temperature. Microwave radiation is particularly effective in exciting water molecules within or on the endless tape, thereby heating the endless tape to the desorption temperature. Infrared radiation, in contrast, selectively excites carbon dioxide, providing an energy-efficient means for releasing bound carbon dioxide in the desorption chamber.

In a particularly advantageous configuration, the heating mechanism in the desorption chamber includes a hot fluid bath, which heats the endless tape and/or the sorbent to at least 90° C. A temperature range of 95° C. to 110° C. offers a balanced approach, facilitating carbon dioxide desorption while minimizing the energy required. Additionally, within this temperature range, the risk of thermal decomposition and degradation of the sorbent remains low. Immersion of the endless tape in a hot fluid bath at 90° C. or higher creates the necessary partial pressure for releasing bound carbon dioxide. Since carbon dioxide solubility in a liquid-particularly water-decreases as temperature increases, the carbon dioxide is desorbed from the sorbent without being absorbed by the liquid. Moreover, the liquid protects the sorbent from oxygen exposure at elevated temperatures, preserving its sorption capacity for carbon dioxide storage. Alternatively, instead of a liquid, the endless tape may be heated to the desorption temperature using a gas or vapor, such as water vapor. Preferred gases or vapors are those that can be easily separated from carbon dioxide due to their condensation temperature and/or density. Water vapor is particularly suitable, as it is inert and does not react with carbon dioxide. It can be readily separated from the carbon dioxide-water vapor mixture in a downstream condensation step, leaving behind concentrated carbon dioxide.

In some examples, the cooling chamber contains a cooling liquid, through which the endless tape is guided to cool the sorbent. The cooling liquid is selected to ensure minimal or no absorption into the sorbent, preventing interference with its capacity to adsorb carbon dioxide. By using a cooling liquid, a substantial amount of heat can be dissipated from the endless tape, enabling rapid cooling over a short distance.

In a particularly preferred configuration, a liquid wiper is positioned at or near the through-opening connecting the cooling chamber to the adsorption chamber. The liquid wiper removes residual cooling liquid from the endless tape, preventing it from being carried into the adsorption chamber. Additionally, reducing the moisture content of the endless tape enhances the uptake of carbon dioxide in the adsorption chamber.

In some examples, the adsorption chamber includes a conveying element, such as a fan, to generate an airflow through the chamber. The inclusion of such a conveying element ensures a consistent gas flow of ambient air, independent of wind conditions at the system's location. This airflow promotes efficient carbon dioxide adsorption.

In an advantageous configuration, multiple deflection elements are arranged within the adsorption chamber to guide the endless tape in a meandering path through the chamber. This arrangement increases the length of the endless tape exposed to the adsorption process, enabling a higher volume of carbon dioxide to be captured and allowing the sorbent to reach saturation. As a result, an efficient capture of carbon dioxide from ambient air is achieved. The orientation of the deflection elements can be adapted based on the type of endless tape used in the system. For an endless tape with a gas-permeable carrier material, it is advantageous for the airflow to pass through the tape multiple times. Conversely, if the endless tape consists of a gas-tight carrier coated with a sorbent, it is preferable to direct the airflow parallel to the endless tape over the longest possible distance.

In some configurations, the endless tape itself may be formed from a gas-permeable carrier material, allowing ambient air to flow through its porous structure, where carbon dioxide is adsorbed by the sorbent. Alternatively, a combination may be employed, in which one portion of ambient air passes through the porous carrier structure, while another portion flows along the surface of the endless tape. In certain configurations, the endless tape may be gas-tight in some sections-particularly along its edges-to enhance mechanical strength, while remaining gas-permeable in its central region. This design enables a combination of airflow through and along the endless tape.

In an advantageous configuration, the desorption chamber includes mechanisms for supplying a carbon dioxide atmosphere. A higher carbon dioxide concentration in the gas flow discharged from the desorption chamber can be achieved by introducing a carbon dioxide atmosphere within the chamber. Additionally, the presence of a carbon dioxide atmosphere protects the sorbent from oxygen uptake, thereby preventing a reduction in its sorption capacity during subsequent cycles of the endless tape.

To facilitate the removal of desorbed carbon dioxide, it is advantageous for the desorption chamber to include an outlet for extracting a carbon dioxide-containing gas flow. In this context, a carbon dioxide-containing gas flow refers to a gas flow with a carbon dioxide concentration of at least 15%, and preferably at least 35%. This ensures that the separated carbon dioxide can be efficiently directed to a storage unit or integrated into a subsequent process, such as the production of synthetic fuel where carbon dioxide serves as a feedstock. Lower carbon dioxide concentrations may still be practical, particularly when water vapor is used to drive carbon dioxide out of the sorbent. In such cases, the water vapor can be subsequently removed from the extracted gas flow through condensation.

In some examples, a water separator is positioned at the outlet or downstream from the outlet to separate water, particularly water vapor, from the carbon dioxide-containing gas flow. To achieve a gas flow with the highest possible carbon dioxide concentration, it may be beneficial to flood the desorption chamber with an inert gas, such as water vapor. Additionally, ambient air contains moisture, which must be removed to obtain a purified carbon dioxide gas stream. To achieve this, a water separator positioned at or downstream from the outlet reduces the moisture content of the extracted carbon dioxide gas.

In a preferred configuration, the endless tape is designed as an endless pouch filled with a sorbent. This design allows for an increased amount of sorbent to be incorporated within the endless tape. The pouch is formed from a gas-permeable material, facilitating the adsorption of carbon dioxide from ambient air while permitting efficient gas exchange through the endless pouch structure.

Alternatively, the endless tape may be configured as a functional woven fabric or a functionalized film incorporating an integrated sorbent. This structure results in a highly durable endless tape with sufficient capacity to accommodate the sorbent. Other variations of the endless tape may include a nonwoven material, a mesh, a gauze, or a filter material, each containing bound sorbent. The functional woven fabric or functionalized film allows for airflow passage, enabling efficient carbon dioxide adsorption in the absorption chamber.

In another example, the endless tape comprises a carrier film coated with a functional layer designed for carbon dioxide sorption. This configuration provides enhanced structural stability, allowing the endless tape to withstand higher tensile forces as it moves through the system. Additionally, the carrier material may be treated to include corrosion resistance, preventing degradation when exposed to heating fluids or cooling liquids. The sorbent coating can be formulated to optimize the uptake and release of carbon dioxide, improving overall efficiency.

In a particularly advantageous configuration, a washcoat is applied between the carrier film and the functional layer. The washcoat facilitates the application of the functional layer and enhances its adhesion to the carrier film, thereby preventing peeling and extending the service life of the endless tape. Furthermore, the washcoat increases the surface area of the functional layer, improving the uptake efficiency of carbon dioxide by the sorbent.

Another aspect of the present disclosure relates to a method for separating carbon dioxide from ambient air using the described system. In this process, carbon dioxide is adsorbed by the sorbent within the endless tape in the adsorption chamber. The endless tape is then heated in the desorption chamber to a temperature of at least 90° C., and preferably between 95° C. and 110° C., facilitating the desorption of carbon dioxide from the sorbent. Subsequently, the endless tape is cooled in the cooling chamber to a temperature below 50° C., and preferably below 35° C., to prepare it for renewed carbon dioxide adsorption.

In some examples, the method disclosed herein enables a comparatively simple and cost-effective separation of carbon dioxide from ambient air. The continuous revolution of the endless tape allows for simultaneous absorption, desorption, and cooling within corresponding sections of the tape, eliminating the need for constant heating, evacuation, and cooling of a sorption chamber. Instead, optimal conditions for both adsorption and desorption can be established within the respective adsorption and desorption chambers. Furthermore, compared to conventional methods, the energy demand is significantly reduced since only the endless tape and sorbent require heating, rather than the entire sorption chamber. The presence of the cooling chamber allows for rapid cooling of the endless tape after desorption, ensuring that each section of the tape is quickly returned to an optimal temperature for carbon dioxide adsorption.

In an advantageous implementation of the method, the temperature in the desorption chamber is maintained at a constant level between 90° C. and 110° C. This approach requires only an initial heating of the desorption chamber, thereby reducing overall energy consumption while ensuring that the chamber atmosphere remains above the desorption temperature for carbon dioxide release from the sorbent.

Alternatively or additionally, the endless tape or the sorbent bound within the tape may be heated using electromagnetic radiation. By employing electromagnetic radiation, energy can be precisely targeted to the endless tape to heat the sorbent to a desorption temperature of at least 90° C. This localized heating eliminates the need to raise the temperature of the entire desorption chamber, as only the endless tape and the sorbent directly associated with it are heated.

In some implementations, microwave radiation is used as the electromagnetic energy source for heating the endless tape and/or sorbent. Alternatively, infrared radiation may be used to achieve the same effect. Both forms of radiation provide efficient and controlled heating, enabling effective desorption of carbon dioxide from the sorbent.

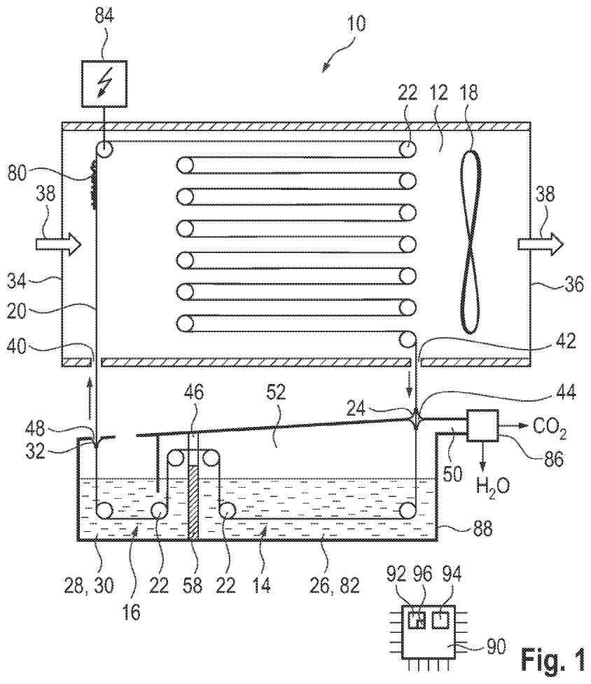

FIG. 1 shows a preferred exemplary embodiment of a system according to the invention for separating carbon dioxide from ambient air 10. The system 10 comprises an adsorption chamber 12 for binding carbon dioxide from the ambient air in a sorbent 80, a desorption chamber 14 for releasing the carbon dioxide bound in the sorbent 80, and a cooling chamber 16 for cooling the sorbent 80 after the carbon dioxide has been released. The system furthermore comprises an endless tape 20, which carries the sorbent 80, and a drive element 84, which is configured to move the endless tape 20 through the adsorption chamber 12, the desorption chamber 14, and the cooling chamber, in that order.

The adsorption chamber 12 has a first inlet opening 34, at which an air flow 38 of ambient air with a carbon dioxide content of 400 to 500 ppm enters the chamber. Alternatively, ambient air with an increased carbon dioxide concentration can also enter the adsorption chamber 12. The adsorption chamber 12 also has a first outlet opening 36, at which the air flow 38 exits the chamber. Additionally, a conveying element 18, in particular a fan, is arranged in the adsorption chamber 12 to convey the gas flow through it. A plurality of deflection elements 22 are arranged in the adsorption chamber 12 to guide the endless tape 20 in a meandering manner, allowing as long a distance of the endless tape 20 as possible to pass through the chamber and thereby enabling the most comprehensive adsorption of carbon dioxide from the ambient air in the sorbent 80.

Moreover, additional support elements, particularly support rollers, can be arranged in the adsorption chamber 12 between the deflection elements 22 to support the endless tape 20 and improve its guidance through the adsorption chamber 12. The adsorption chamber 12 also has a second inlet opening 40, through which the endless tape 20 enters the chamber. Additionally, the chamber features a second outlet opening 42, through which the endless tape 20 is guided out of the adsorption chamber 12. A sealing element 24 is arranged at a first through-opening 44, which connects the adsorption chamber 12 to the desorption chamber 14, to minimize gas exchange between the two chambers.

The desorption chamber 14 comprises a pan 88 that holds a hot fluid bath 26. The desorption chamber 14, particularly the pan 88 for receiving the fluid bath 26, can be heated by means of heating elements 82 to achieve a desorption temperature of at least 90° C., at least in parts. The desorption chamber 14 has an outlet 50 through which a carbon dioxide-rich gas flow is discharged from the chamber and supplied to a storage unit, which is not shown, or to a process where carbon dioxide serves as the starting material. A water separator 86 can be arranged at the outlet 50 or downstream from it to separate water vapor from the carbon dioxide-rich gas flow. The desorption chamber 14 is maintained under a carbon dioxide atmosphere 52. It is important to ensure that the temperature in the desorption chamber 14 remains consistently in the range of 90° to 120° C., preferably between 95° and 105° C., to avoid continual heating and cooling of the chamber and thereby minimize energy demand. The endless tape 20 is immersed in the fluid bath 26, allowing the sorbent 80 to reach a temperature and a partial pressure at which the carbon dioxide bound in the sorbent 80 desorbs and rises from the fluid bath 26 into the atmosphere of the desorption chamber 14. The endless tape 20 is guided via additional deflection elements 22 from the desorption chamber 14 into the cooling chamber 16 through a second through-opening 46 in the divider wall 58.

In the cooling chamber 16, the endless tape 20 is immersed in a cooling liquid 28, for example, water 30, to dissipate heat from the endless tape 20 and cool the sorbent 80. A fluid separator 32 is arranged at a third through-opening 48, which connects the cooling chamber 16 to the adsorption chamber 12, to wipe the cooling liquid 28 off the endless tape 20 and reduce the moisture of the sorbent 80 before the endless tape 20, including the sorbent 80, is fed back into the adsorption chamber 12. Water 30 is the ideal cooling liquid when the sorbent 80 itself does not absorb any water 30, or only a little water 30, or has limited capacity for carbon dioxide storage despite the absorption of water. Alternatively, another cooling liquid may be used that does not limit, or only insignificantly limits, the uptake of carbon dioxide by the sorbent 80.

The system 10 also includes a control unit 90 comprising a memory unit 92 and a processing unit 94. Machine-readable program code 96 is stored in the memory unit 92, which, when executed by the processing unit 94, controls the system for separating carbon dioxide from the ambient air in either an open or closed loop.

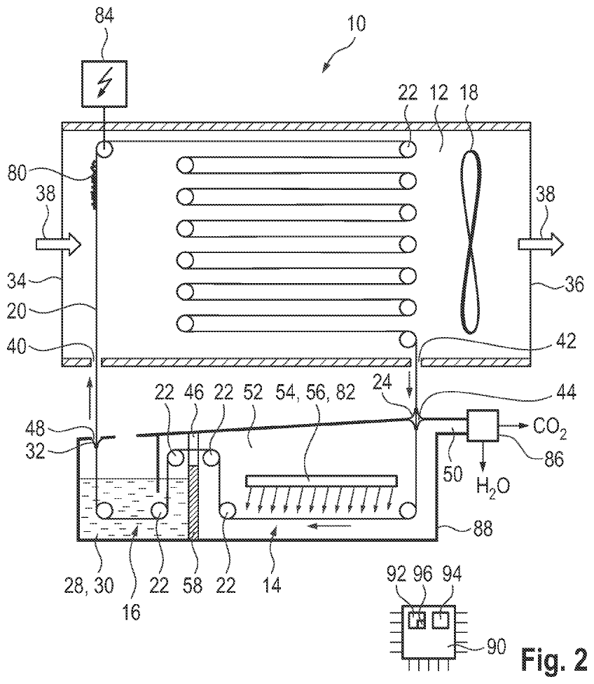

FIG. 2 shows a further preferred exemplary embodiment of a system 10 according to the invention for separating carbon dioxide from the ambient air. The system 10 comprises an adsorption chamber 12 for binding carbon dioxide from the ambient air in a sorbent 80, a desorption chamber 14 for releasing the carbon dioxide bound in the sorbent 80, and a cooling chamber 16 for cooling the sorbent 80 after the carbon dioxide bound in the sorbent 80 has been released. In some examples, the system also includes an endless tape 20, which carries the sorbent 80, and a drive element 84, which is configured to move the endless tape 20 through the adsorption chamber 12, the desorption chamber 14, and the cooling chamber, in that order.

The adsorption chamber 12 has a first inlet opening 34, at which an air flow 38 of ambient air with a carbon dioxide content of 400 to 500 ppm enters the adsorption chamber 12. The adsorption chamber 12 also has a first outlet opening 36, through which the air flow 38 exits the adsorption chamber 12. Additionally, a conveying element 18, specifically a fan, is arranged in or at the adsorption chamber 12 to convey the gas flow through the chamber. A plurality of deflection elements 22 are arranged in the adsorption chamber 12 to guide the endless tape 20 in a meandering manner, maximizing the distance the tape travels through the chamber and thereby enabling the most comprehensive adsorption of carbon dioxide from the ambient air into the sorbent 80. The adsorption chamber 12 also has a second inlet opening 40, through which the endless tape 20 enters the chamber. Furthermore, the adsorption chamber 12 has a second outlet opening 42, through which the endless tape 20 exits the chamber. A sealing element 24 is arranged at a first through-opening 44, connecting the adsorption chamber 12 to the desorption chamber 14, to minimize gas exchange between the two chambers.

To release the carbon dioxide bound in the sorbent 80 in the desorption chamber 14, heating means 82 in the form of an infrared emitter 54 and/or a microwave emitter 56 are arranged in the desorption chamber 14. This allows the endless tape 20 to be heated in sections to the desorption temperature. Carbon dioxide desorbs from the sorbent 80 and can be discharged via an outlet 50 for supply to a storage unit, which is not shown, or to a process where the carbon dioxide serves as a starting material. The desorption chamber 14 is maintained under a carbon dioxide atmosphere 52.

Furthermore, means for lowering the pressure in the desorption chamber 14, in particular a vacuum pump, can be arranged at the desorption chamber 14 to reduce the partial pressure in the desorption chamber 14 and facilitate the desorption of carbon dioxide from the sorbent 80. The endless tape 20 is guided via further deflection elements 22 from the desorption chamber 14 into the cooling chamber 16 at a second through-opening 46 in the divider wall 58.

In the cooling chamber 16, the endless tape 20 is immersed in a cooling liquid 28, specifically water 30, to dissipate heat from the endless tape 20 and cool the sorbent 80. A fluid separator 32 is positioned at a third through-opening 48, which connects the cooling chamber 16 to the adsorption chamber 12, to wipe the cooling liquid 28 off the endless tape 20 and reduce the moisture of the sorbent 80 before the endless tape 20, including the sorbent 80, is fed back to the adsorption chamber 12. Alternatively, the endless tape 20 can also be cooled by blowing a cold gas flow into the cooling chamber 16, which allows for the elimination of a cooling circuit that includes a cooling liquid 28, enabling the endless tape 20 to be fed to the adsorption chamber 12 in a substantially dry state.

The system 10 also comprises a control unit 90 that includes a memory unit 92 and a processing unit 94. Machine-readable program code 96 is stored in the memory unit 92, which, when executed by the processing unit 94, controls the system for separating carbon dioxide from the ambient air in either an open or closed loop.

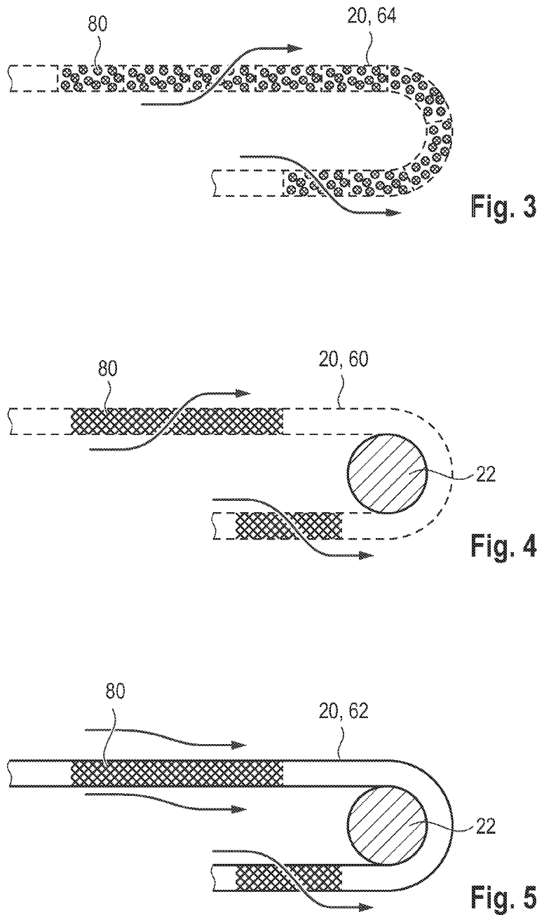

FIG. 3 shows an exemplary embodiment of an endless tape 20 for such a system 10. The endless tape 20 is designed as an endless pouch 64 in this embodiment, which is filled with a sorbent 80. The endless pouch 64 has a gas-permeable structure, allowing a gas flow to pass through it, so that carbon dioxide can be bound in the adsorption chamber 12 and released from the sorbent 80 in the desorption chamber 14.

FIG. 4 shows another exemplary embodiment of an endless tape 20 for such a system 10. In this instance, the endless tape 20 is designed as a functionalized woven fabric 60, which incorporates the sorbent 80 and features a gas-permeable structure that allows a gas flow to pass through it, enabling carbon dioxide to be bound in the adsorption chamber 12 and released from the sorbent 80 in the desorption chamber 14.

FIG. 5 shows yet another exemplary embodiment of an endless tape 20 for such a system 10. The endless tape 20 is designed as a functionalized film 62 in this embodiment, to which a sorbent 80 adheres. The functionalized film 62 can be gas-permeable or, as shown in FIG. 5, substantially gas-impermeable. Carbon dioxide from the ambient air is bound when an air flow moves along the surface of the functionalized film 62. In this embodiment as well, desorption of the carbon dioxide in the desorption chamber 14 occurs by increasing the temperature and possibly simultaneously lowering the partial pressure. Alternatively, in the case of a gas-permeable film 62, the sorbent can also be arranged between different layers of the film 62, through which a gas flow can pass, allowing carbon dioxide to be bound in the adsorption chamber 12 and released from the sorbent 80 in the desorption chamber 14.

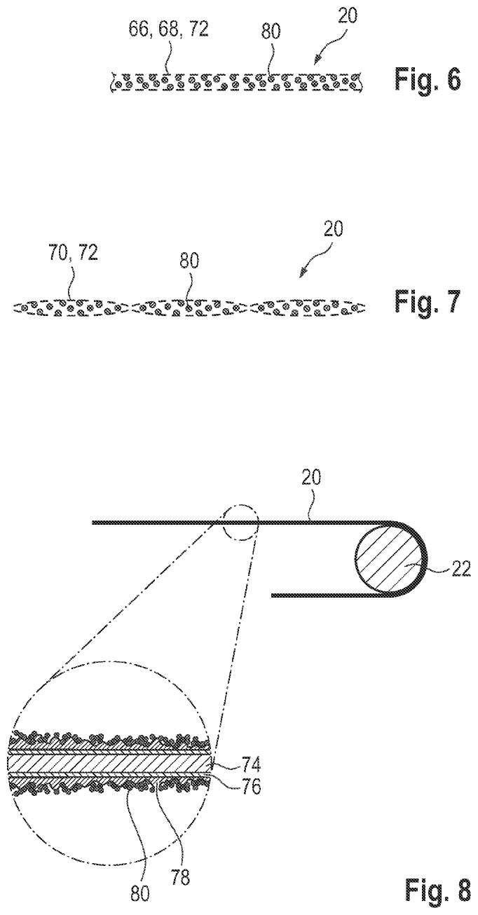

FIG. 6 shows a schematic representation of the design of a preferred exemplary embodiment of the endless tape 20. The endless tape 20 is designed as gauze, a nonwoven 66, a mesh 68, or a similar woven fabric 72 made of a gas-permeable material, with the sorbent 80 kept available between the layers of the endless tape 20.

FIG. 7 shows another schematic representation of the design of a preferred exemplary embodiment of the endless tape 20. The endless tape 20 is designed as a filter medium 70 and can include multiple pockets where the sorbent 80 is stored.

FIG. 8 shows an alternative exemplary embodiment of the endless tape 20 for such a system 10. The endless tape 20 comprises a preferably gas-impermeable, tear-resistant carrier film 74, which is coated with a washcoat 76 and a functional layer 78, wherein the functional layer 78 contains a sorbent 80. The surface area of the endless tape 20 can be increased by the coating to optimize the adsorption and subsequent desorption of carbon dioxide. In this specific embodiment, carbon dioxide is captured in the absorption chamber 12 when the airflow comes into contact with a reactive surface of the functional layer 78. In this embodiment as well, the desorption of the carbon dioxide in the desorption chamber 14 occurs by increasing the temperature and possibly simultaneously lowering the partial pressure.

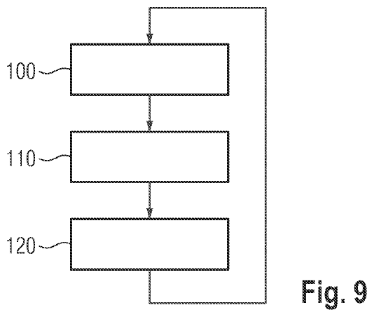

FIG. 9 shows a flow chart for carrying out a method according to the invention for separating carbon dioxide from ambient air using such a system 10. In a method step <100>, the endless tape 20 is pulled through the adsorption chamber 12 by the drive element 84, during which carbon dioxide from the ambient air is bound in the sorbent 80 in a section of the endless tape 20. In a subsequent method step <110>, the corresponding section of the endless tape 20 is pulled into the desorption chamber 14 and heated to a temperature of at least 90° C., causing the carbon dioxide bound in the sorbent 80 to be desorbed from the endless tape 20. In a method step <120>, the endless tape 20 is moved into the cooling chamber 16 for cooling, where the corresponding section of the endless tape 20 is cooled to a temperature of less than 50° C., preferably to a temperature between 0° C. and 30° C., to enable the renewed uptake of carbon dioxide in the sorbent 80 of the endless tape 20.

### LIST OF REFERENCE NUMERALS

10 system
12 adsorption chamber
14 desorption chamber
16 cooling chamber
18 conveying element
20 endless tape
22 deflection element
24 sealing element
26 hot fluid bath
28 cooling liquid
30 water
32 fluid separator
34 first inlet opening
36 first outlet opening
38 air flow
40 second inlet opening
42 second outlet opening
44 first through-opening
46 second through-opening
48 third through-opening
50 outlet
52 carbon dioxide atmosphere
54 infrared emitter
56 microwave emitter
58 divider wall
60 functional woven fabric
62 functionalized film
64 endless pouch
66 nonwoven
68 mesh
70 filter material
72 woven fabric
74 carrier film
76 washcoat
78 functional layer
80 sorbent
82 heating means
84 drive element
86 water separator
88 pan
90 control unit
92 memory unit
94 processing unit
96 program code

1-15. (canceled)

16. A system for separating carbon dioxide from ambient air, comprising:
an adsorption chamber configured to bind carbon dioxide from ambient air in a sorbent;
a desorption chamber configured to release carbon dioxide bound in the sorbent, wherein the desorption chamber comprises a heating mechanism configured to heat the sorbent;
a cooling chamber configured to cool the sorbent after the release of carbon dioxide;
an endless tape configured to support or contain the sorbent; and
a drive element configured to move the endless tape through the adsorption chamber, the desorption chamber, and the cooling chamber.

17. The system of claim 16, wherein the heating mechanism in the desorption chamber comprises at least one of an infrared emitter and a microwave emitter.

18. The system of claim 16, wherein the heating mechanism in the desorption chamber comprises a hot fluid bath having a temperature of at least 90° C.

19. The system of claim 16, further comprising a cooling liquid contained within the cooling chamber, wherein the endless tape is guided through the cooling liquid to cool the sorbent.

20. The system of claim 19, further comprising a fluid separator positioned at or near a through-opening connecting the cooling chamber to the adsorption chamber, the fluid separator configured to remove residual cooling liquid from the endless tape.

21. The system of claim 16, further comprising a conveying element positioned in or at the adsorption chamber, the conveying element configured to generate an airflow through the adsorption chamber.

22. The system of claim 16, further comprising a plurality of deflection elements arranged within the adsorption chamber, wherein the endless tape is guided in a meandering path through the adsorption chamber by the deflection elements.

23. The system of claim 16, wherein the desorption chamber is supplied with a carbon dioxide atmosphere.

24. The system of claim 16, further comprising an outlet positioned at the desorption chamber and configured to remove a carbon dioxide-containing gas flow having a carbon dioxide concentration of at least 25%.

25. The system of claim 24, further comprising a water separator positioned at or downstream from the outlet, the water separator configured to separate water from the carbon dioxide-containing gas flow.

26. The system of claim 16, wherein the endless tape comprises at least one of an endless pouch, a functional woven fabric, a functional film, a filter material, a nonwoven material, or a mesh, and wherein the sorbent is incorporated into the endless tape.

27. The system of claim 16, wherein the endless tape comprises a carrier film coated with a functional layer configured for carbon dioxide sorption.

28. A method for separating carbon dioxide from ambient air, comprising:
binding carbon dioxide from ambient air in a sorbent of an endless tape within an adsorption chamber;
moving the endless tape from the adsorption chamber to a desorption chamber;
heating the endless tape in the desorption chamber to a temperature of at least 90° C., thereby releasing carbon dioxide from the sorbent;
moving the endless tape from the desorption chamber to a cooling chamber; and
cooling the endless tape in the cooling chamber to a temperature below 50° C., enabling renewed uptake of carbon dioxide in the sorbent.
The method of claim 28, wherein the heating of the endless tape in the desorption chamber is performed using at least one of an infrared emitter and a microwave emitter.

29. The method of claim 28, wherein the heating of the endless tape in the desorption chamber is performed using a hot fluid bath at a temperature of at least 90° C.

31. The method of claim 28, further comprising directing an airflow through the adsorption chamber using a conveying element to promote carbon dioxide binding in the sorbent.

32. The method of claim 28, further comprising supplying a carbon dioxide atmosphere to the desorption chamber to facilitate the release of carbon dioxide from the sorbent.

33. The method of claim 28, further comprising removing a carbon dioxide-containing gas flow from the desorption chamber via an outlet, wherein the removed gas flow has a carbon dioxide concentration of at least 25%.

34. The method of claim 33, further comprising separating water from the carbon dioxide-containing gas flow using a water separator positioned at or downstream from the outlet.

35. A system for separating carbon dioxide from ambient air, comprising:
an adsorption chamber configured to bind carbon dioxide from ambient air in a sorbent;
a desorption chamber configured to release carbon dioxide bound in the sorbent, wherein the desorption chamber comprises a heating mechanism configured to elevate the temperature of the sorbent to facilitate desorption;
a cooling chamber configured to cool the sorbent after carbon dioxide release;
an endless tape configured to support or contain the sorbent, wherein the endless tape comprises a carrier film coated with a functional layer configured for carbon dioxide sorption;
a drive element configured to move the endless tape through the adsorption chamber, the desorption chamber, and the cooling chamber; and
a fluid separator positioned at or near a through-opening connecting the cooling chamber to the adsorption chamber, the fluid separator configured to remove residual cooling liquid from the endless tape.
